(19) United States
(12) Patent Application Publication
(10) Pub. No.: US 2025/0139895 A1
(43) Pub. Date: May 1, 2025

(54) METHOD AND SYSTEMS FOR DYNAMICALLY FEATURING ITEMS WITHIN THE STORYLINE CONTEXT OF A DIGITAL GRAPHIC NARRATIVE

(71) Applicant: Global Publishing Interactive, Inc., Troy, OH (US)

(72) Inventors: Robert Hoffer, Miami Beach, FL (US); Christopher Carter, Bloomingdale, IL (US); Shaun Rowan, Troy, OH (US)

(21) Appl. No.: 18/496,352

(22) Filed: Oct. 27, 2023

(51) Int. Cl. G06T 17/10; G06T 7/10; G06T 19/00; G06V 10/40

(52) U.S. Cl. CPC G06T 17/10; G06T 7/10; G06T 19/006; G06V 10/40

(57) ABSTRACT

A system and method are provided for generating a costume corresponding to graphic narrative (e.g., based, in part, on costumes depicted in images of a digital graphic narrative). Panels of the digital graphic narrative are segmented into elements (e.g., using semantic segmentation models like Fully Convolutional Networks), and clothing elements are identified as outfits/costumes worn by the characters. Based on multiple viewing angles provided by a plurality of images, data such as color and texture of the outfits/costumes is extracted and a digital costume model is created. The digital costume model can include animated and real-life components for rendering realistic and animated representations of the digital costume model. The digital costume model can be customized, shared on social media, used to help render a virtual environment, and used to fabricate a physical costume.

### BACKGROUND

Costume play, which can also be referred to cosplay, is an activity and performance art in which participants wear costumes and fashion accessories to represent a specific character. For example, attendees at comic conventions often attend the conventions dressed up as characters from graphic narratives, such as comic books or sci-fi or fantasy television series and movies.

Cosplay costumes vary greatly and can range from simple themed clothing to highly detailed costumes. Often, the intention with cosplay costumes is to replicate a specific character. Relatedly, when in costume, some cosplayers often seek to adopt the affect, mannerisms, and body language of the characters they portray. The characters chosen to be cosplayed may be sourced from any movie, TV series, book, comic book, video game, music band, anime, or manga.

Cosplayers can obtain their apparel through many different methods. Manufacturers produce and sell packaged outfits for use in cosplay, with varying levels of quality. These costumes are often sold online, but also can be purchased from dealers at conventions. Individuals/sole proprietors can also work on commission, creating custom costumes, props, or wigs designed and fitted to the individual. Other cosplayers, who prefer to create their own costumes, still provide a market for individual elements, and various raw materials, such as unstyled wigs, hair dye, cloth and sewing notions, liquid latex, body paint, costume jewelry, and prop weapons.

Many cosplayers create their own outfits. In the creation of the outfits, much time is given to detail and qualities, thus the skill of a cosplayer may be measured by how difficult the details of the outfit are and how well they have been replicated.

Generally, commercially available costumes are only available for the more popular characters, and then the variety of different costumes may be limited even for these popular characters. There is an unmet need for commercially available costumes that are customizable. Also, there can be a delay (sometimes sizable) between the demand for new costumes and the fulfillment of the demand.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example of panels arranged in a page of a digital graphic narrative, in accordance with some embodiments.

FIG. 2A illustrates a rear view of an example rendering of a digital costume model, in accordance with some embodiments.

FIG. 2B illustrates a side view of an example rendering of a costume mode, in accordance with some embodiments.

FIG. 2C illustrates a front view of an example rendering of a costume mode, in accordance with some embodiments.

FIG. 3A illustrates an example of a desktop computing device for editing and/or viewing a modified graphic narrative, in accordance with some embodiments.

FIG. 3B illustrates an example of a handheld computing device for viewing the modified graphic narrative, in accordance with some embodiments.

FIG. 3C illustrates an example of a virtual reality (VR) headset, in accordance with some embodiments.

FIG. 4 illustrates an example of a block diagram for a system of generating and using a digital costume model (e.g., interacting with the digital costume model, rendering the digital costume model in a virtual environment, and producing a costumed based on the costume mode, in accordance with some embodiments.

FIG. 5 illustrates an example of a flow diagram for a method of generating and using the digital costume model, in accordance with some embodiments.

FIG. 6 illustrates an example of a block diagram of training a generative adversarial network (GAN), in accordance with some embodiments.

FIG. 7A illustrates an example of a block diagram of training an artificial intelligence (AI) processor, in accordance with some embodiments.

FIG. 7B illustrates an example of a block diagram for using the trained AI processor, in accordance with some embodiments.

FIG. 8 illustrates an example of a block diagram of a computing device, in accordance with some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In one aspect, a method is provided for generating a digital costume model based, in part, on images from a digital graphic narrative. The method includes segmenting, using at least one machine-learning model, elements within images of a two-dimensional digital graphic narrative, identifying, using the at least one machine-learning model, segmented elements, wherein the identified segmented elements include identified clothing elements worn by characters in the two-dimensional digital graphic narrative. The method further includes analyzing, using the at least one machine-learning model, the clothing elements to extract and predict a plurality of polygons that represent the clothing elements in a digital three-dimensional shape, and generating a three-dimensional digital costume model based, in part, on the plurality of polygons.

In another aspect, the method may also include ingesting pages of the digital graphic narrative, wherein the digital graphic narrative comprises a digital version and/or print version selected from the group consisting of comic books, manga, manhwa, and manhua, cartoons, and anime; and identifying panels within the pages of the digital graphic narrative, and then segmenting the elements within images of the panels of the digital graphic narrative.

In another aspect, the method may also include generating a model for a three-dimensional virtual environment including a virtual costume based on the three-dimensional digital costume model that fits on a wireframe associated with a character, and rendering the three-dimensional virtual environment.

In another aspect, the method may also include that the rendering of the virtual environment further includes the virtual environment is rendered to show an avatar of the user wearing a virtual costume based on the digital costume model, and the virtual environment is rendered in a style of the digital graphic narrative.

In another aspect, the method may also include that the virtual environment is an immersive environment rendered using a virtual reality (VR) technology or an augmented reality (VR) technology. In another aspect, the method may also include that the virtual environment is generated using a generative adversarial network (GAN), a variational autoencoder (VAE), or stable diffusion.

In another aspect, the method may also include that the analyzing of the clothing elements to extract the data further includes: identifying a plurality of clothing elements from different images of the digital graphic narrative that correspond to a same costume of a same character of the digital graphic narrative; identifying respective orientations of the plurality of clothing elements from the different images of the digital graphic narrative; identifying one or more colors of the plurality of clothing elements; and identifying one or more textures of the plurality of clothing elements.

In another aspect, the method may also include that the generating of the digital costume model further includes determining matches between costume materials and the identified one or more colors and between the costume materials and the identified one or more textures; determining the digital costume model based on the matches; and generating a list of materials, quantities of the materials, and instructions for fabricating a physical costume based on the digital costume model.

In another aspect, the method may also include sending a request to a vendor to fabricate the physical costume based on the list of materials, the quantities of the materials, and the instructions. In another aspect, the method may also include that the instructions for fabricating the physical costume include a tailoring pattern for cutting and sewing respective pieces of cloth, three-dimensional printing instructions, fabric printing instructions, and/or laser cutting instructions.

In another aspect, the method may also include receiving user inputs indicating changes to the digital costume model, and customizing the digital costume model based on the user inputs. In another aspect, the method may also include that receiving the user inputs further comprises using an artificial intelligence method to guide a user through setting customization parameters as the user inputs.

In another aspect, the method may also include that the digital costume model includes an animated component and a real-life component, the animated component representing an appearance of the digital costume model when rendered for an animated virtual environment, and the real-life component representing an appearance of the digital costume model when rendered to show how a physical costume is predicted to appear; and the method further comprises customizing the animated component of the digital costume model independently of the real-life component of the digital costume model.

In another aspect, the method may also include that the segmenting of the elements within the panels further includes applying a first machine learning (ML) method to a panel of the panels, the first ML method determining, within the panel, bounded regions corresponding background, foreground, text bubbles, objects, and/or characters, and identifying the bounded regions as the segmented elements.

In another aspect, the method may also include sharing, on one or more social sharing platforms, information about the digital costume model and/or images based on the digital costume model. In another aspect, the method may also include that the one or more social sharing platforms comprising social media, a fan forum, a virtual forum, and online community, a chart room, a public forum, or a virtual community space.

In another aspect, the method may also include that the ML method is selected from the group consisting of a Fully Convolutional Network (FCN) method, a U-Net method, a SegNet method, a Pyramid Scene Parsing Network (PSPNet) method, a DeepLab method, a Mask R-CNN, an Object Detection and Segmentation method, a fast R-CNN method, a faster R-CNN method, a You Only Look Once (YOLO) method, a fast R-CNN method, a PASCAL VOC method, a COCO method, a ILSVRC method, a Single Shot Detection (SSD) method, a Single Shot MultiBox Detector method, a Vision Transformer, ViT) method, a K-means method, an Iterative Self-Organizing Data Analysis Technique (ISODATA) method, a YOLO method. A ResNet method, a ViT method, a Contrastive Language-Image Pre-Training (CLIP) method, a convolutional neural network (CNN) method, a MobileNet method, and an EfficientNet method.

In one aspect, a computing apparatus includes a processor. The computing apparatus also includes a memory storing instructions that, when executed by the processor, configure the apparatus to perform the respective steps of any one of the aspects of the above-recited methods.

In one aspect, a computing apparatus includes a processor. The computing apparatus also includes a memory storing instructions that, when executed by the processor, configure the apparatus to segment elements within images of a digital graphic narrative; identify segmented elements including which of the segmented elements are clothing elements worn by characters in the digital graphic narrative; analyze the clothing elements to extract data of the clothing elements; and generate a digital costume model based, in part, on the extracted data.

In another aspect, the computing apparatus further includes that, when executed by the processor, the stored instructions further configure the apparatus to receive user inputs indicating changes to the digital costume model, and customize the digital costume model based on the user inputs; share, on one or more social sharing platforms, information about the digital costume model and/or images based on the digital costume model; generate a model of a virtual environment comprising a virtual costume based on the digital costume model, render the virtual environment; and send a request to a vendor to fabricate the physical costume based on the list of materials, the quantities of the materials, and the instructions.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art to enable a multi-modal transformation and generation of three-dimensional costumes in a virtual or digital formats as well as in a printable format from two-dimensional characters from various visual content in graphic narratives. The term “graphic narrative” as used herein includes all stories that include a graphic medium to communicate the story including, e.g., but not limited to, comic books, manga, manhwa, and manhua, cartoons, anime, live-action and animated television series, and live-action and animated movies.

In the field of cosplay and comic fandom, fans often encounter challenges in creating accurate, fitting, and high-quality cosplay costumes of their favorite characters. Further, there is a lack of experiences of virtual cosplay in digital spaces such as augmented reality (AR) and virtual reality.

Accordingly, there is a need for a new or improved platform that enables users to generate and explore models of digital costumes based on characters in graphic narratives. Further, there is a need for users to be able to interact with the digital costume models in various ways, such as, customizing the digital costume models, placing the digital costume models in a virtual environment, sharing the digital costume models on social media, and requesting a commercial vendor to fabricate a physical costume based on the costume models.

The methods and systems disclosed herein address these limitations by using generative artificial intelligence (AI) to provide virtual and real-life cosplay costumes based on graphic narratives (e.g., from a comic book data corpus). According to certain non-limiting examples, methods and systems disclosed herein use machine learning image models, including, e.g., a diffusion model (DM), a latent diffusion model (LDM), a stable diffusion model (SDM), variational autoencoder (VAE).

According to certain non-limiting examples, methods and systems disclosed herein can include a data extraction processor, a generative AI processor, a virtual experience processor, a real-life production processor, and a customization processor. The data extraction processor is used to extract and analyze the styles of characters from a comic book data corpus. The generative AI processor is used to generate virtual cosplay costumes based on the analyzed styles and user inputs (e.g., measurements of the user and photos of the user). The virtual experience processor enables users to enter comic books dressed in the generated virtual cosplay costumes in an immersive digital environment. The real-life production processor is used to create real-life versions of the virtual cosplay costumes. The customization processor is used to personalize the virtual and real-life cosplay costumes based on additional user inputs.

According to certain non-limiting examples, methods and systems disclosed herein can include that the data extraction processor extracts data from a comic book data corpus, including character designs, costume details, color schemes, patterns, etc. The extracted data provides inputs for the Generative AI processor to create virtual cosplay costumes. The generative AI processor uses one or more types of machine learning (ML) image models to create unique and accurate virtual cosplay costumes from the extracted data. The ML image models can include, e.g., but are not limited to, stable diffusion methods to create virtual cosplay costumes.

The virtual experience processor enables users to interact and experience the virtual cosplay costumes in a virtual environment. For example, the virtual cosplay costumes created by the generative AI processor can be implemented into an immersive digital environment, allowing users to experience their favorite comic book scenarios while dressed as their preferred characters. The real-life production processor takes the virtual cosplay costume designs and transforms them into real-life cosplay costumes. This includes using materials and manufacturing techniques that best replicate the design and style of the comic book character's costume. The customization processor allows users to modify both the virtual and real-life costumes. For example, users can input photos of themselves and other specific preferences to further personalize the costumes. The sharing processor allows users to share their virtual and real-life cosplay costumes on various digital platforms, encouraging social interaction and community building.

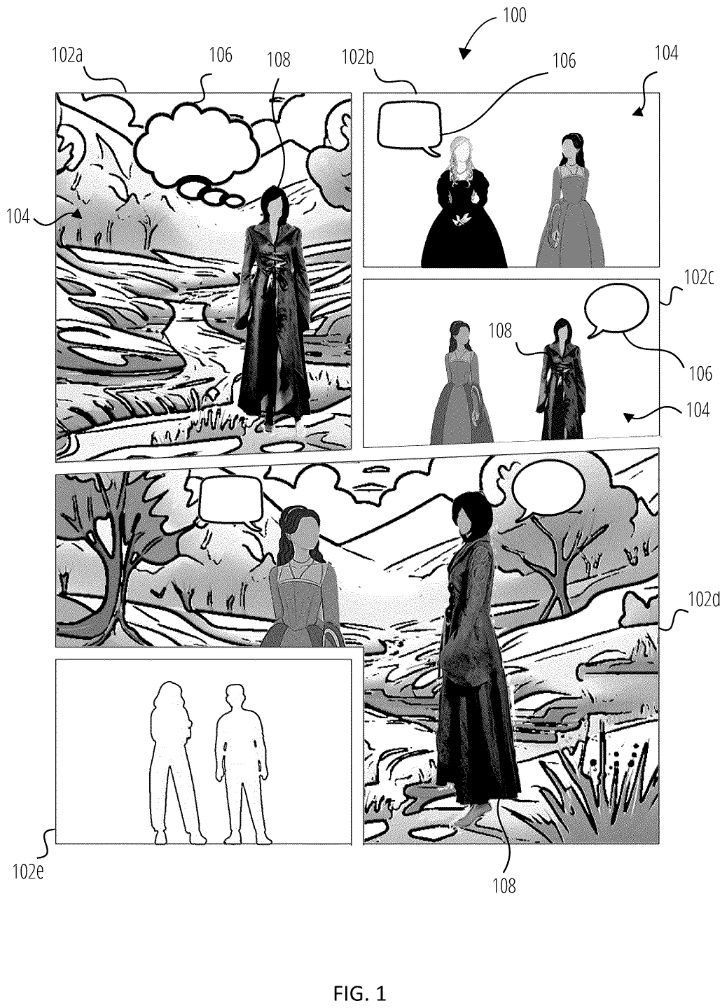

FIG. 1 illustrates a page 100 from a digital graphic narrative (e.g., a comic book, manga, manhwa, manhua, anime, animated moving picture, etc.). The digital page 100 includes five panels (i.e., a first panel 102a, a second panel 102b, a third panel 102c, a fourth panel 102d, and a fifth panel 102c). The respective panels can be segmented into parts, including, e.g., a background 104, a foreground 108, and bubbles 106. These parts can be further subdivided into elements, such as characters, objects, text, signs, etc. For example, the first panel 102a includes the background 104, the foreground 108, and the bubble 106. Similarly, the other panels can generally be segmented into the background 104, the foreground 108, and the bubble 106.

The system and method disclosed herein generate costume models for various characters in a digital graphic narrative. Consider that the different views of the same character are provided in the first panel 102a, the third panel 102c, and the fourth panel 102d. Various artificial intelligence (AI) or machine learning (ML) methods can be used to segment the panels into parts such as the foreground 108 and to detect which parts of the foregrounds 108 represent the same characters, which portions of the images correspond to their clothing/costumes, and in which representations of a given character is wearing the same clothing/costumes. Based on images in the digital graphic narrative of the character's clothing/costumes the AI or ML methods can generate a corresponding costume model and interact with the digital costume model in various ways, such as viewing it in a virtual environment, customizing the digital costume model, sharing it on social media, and requesting a vendor to fabricate/manufacture a costume based on the digital costume model.

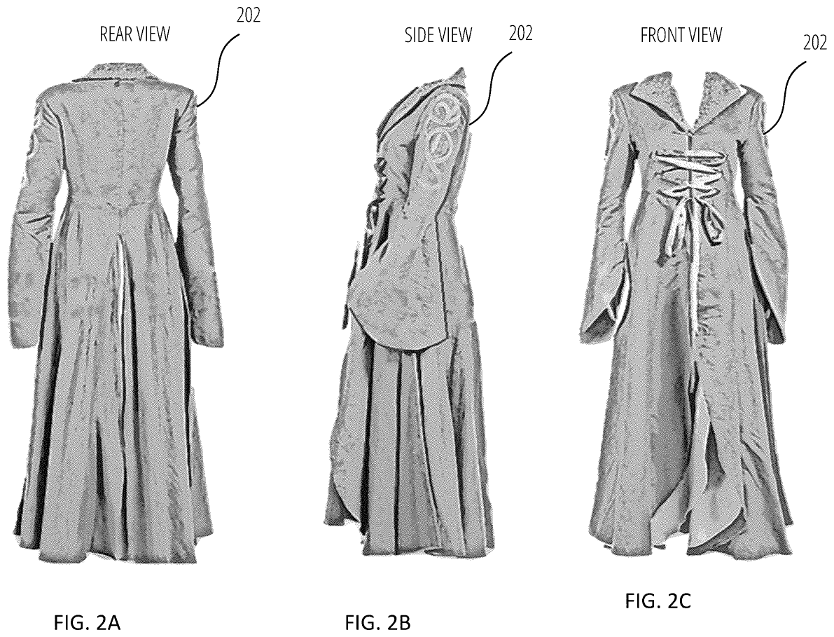

FIGS. 2A-2C illustrate a non-limiting example of different views of a rendering of a model of a digital costume 202. FIG. 2A illustrates a rear view of the digital costume 202. FIG. 2B illustrates a side view of the digital costume 202, and FIG. 2C illustrates a front view of the digital costume 202.

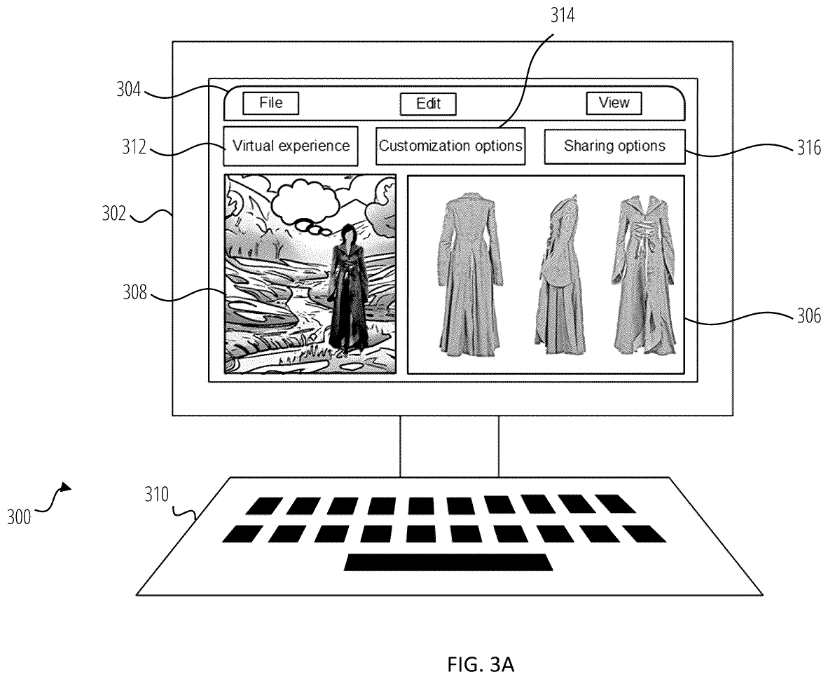

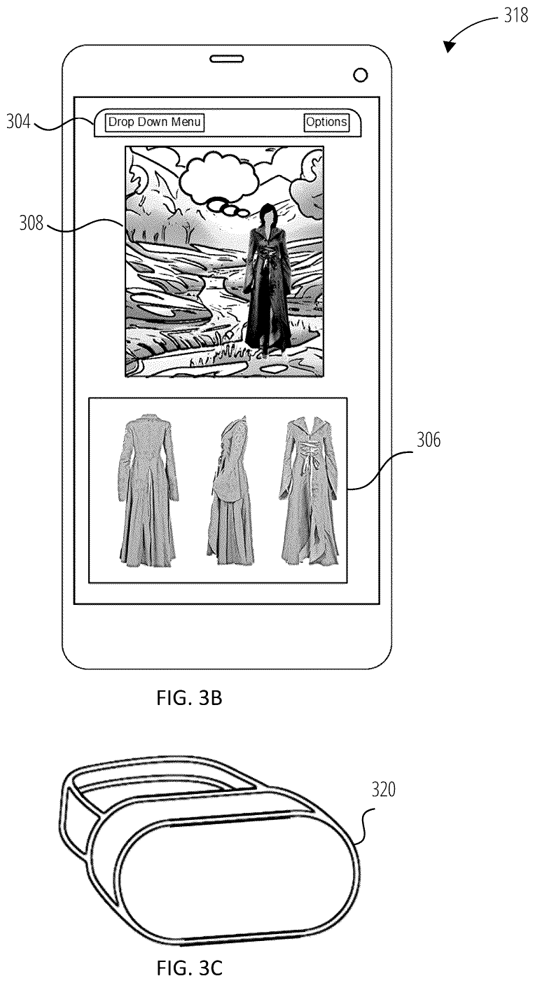

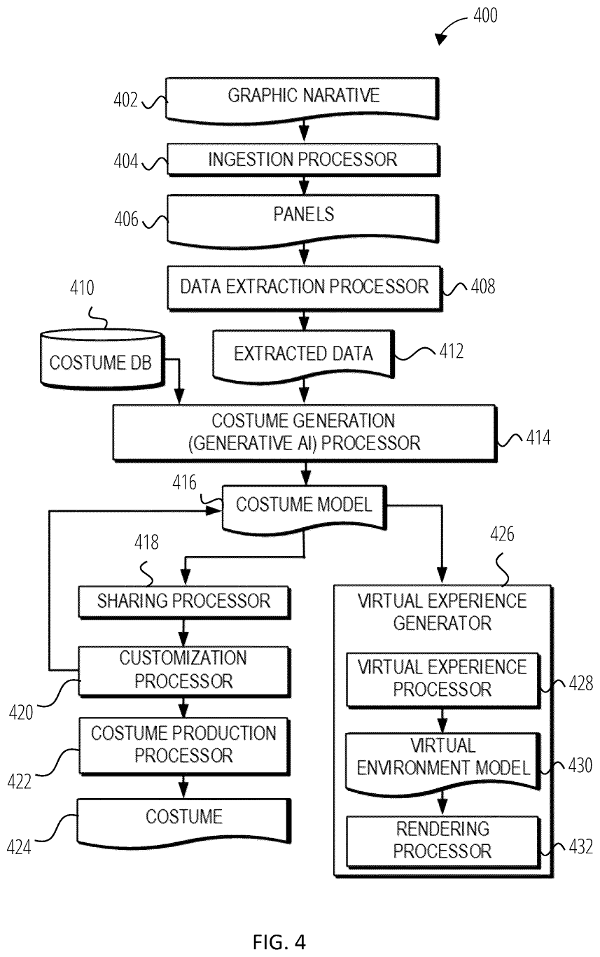

FIG. 3A illustrates an example computing system 300 for generating and interacting with a digital costume generated from a digital graphic narrative. Computing system 300 includes a display 302 (e.g., a computer monitor) and an input device 310 (e.g., a mouse and/or keyboard). The display 302 displays a window that includes a rendering of the digital costume 202 in the costume window 306, a rendering of a virtual environment 308, a menu ribbon 304, and various input windows that enable user inputs to modify or set various options related to the costume 202. These input windows can include, e.g., windows for entering the virtual display options 312, customization options 314, and sharing options 316. The menu ribbon 304 can provide options for changing a view, changing editing tools, saving a file, etc.

The virtual display options 312 may enable a user to view the costume in the virtual environment 308. For example, the user can create an avatar that represents the user, and the avatar can be displayed wearing the costume. The customization options 314 can enable the user to input/select parameters and values to customize the costume and/or avatar. For example, the user can modify the materials used in the costume, the size or dimensions of the costume, the tailoring pattern of the costume, and/or colors of the costume. Further, the user can enter their height, weight, waist size, inseam, bust size, arm length, and/or other dimensions that would be used by a tailor to produce an article of clothing. The sharing options 316 can enable a user to share, on various social media platforms, the content of the costume, various renderings of the costume, images of the virtual environment 308, and/or other information/content related to the costume.

The virtual environment 308 can be, e.g., a rendering generated to look like an environment of the digital graphic narrative, and this environment includes a rendering of an avatar of the user wearing the costume. The virtual environment 308 can be generated using generative AI. The costume window 306 can allow the user to view how the costume is predicted to appear in real life or in a virtual environment. The virtual display options 312 and customization options 314 can allow a user to select one or more parameters to modify the virtual environment 308 or the costume as it would be produced in real life or as it would appear upon being rendered in the virtual environment 308. For example, the user can select a panel of the digital graphic narrative to be redrawn to include an avatar of the user wearing the costume that is generated based on a digital costume model. The generative AI method can learn the style of the digital graphic narrative and render the virtual environment 308 to be compatible with being placed in the context of the digital graphic narrative.

FIG. 3B illustrates a mobile device 318 for displaying a rendering of a costume that is modeled on clothing worn by characters in a digital graphic narrative. According to certain non-limiting examples, the mobile device 318 includes a menu ribbon 304 that allows a viewer to change the display settings or customize the viewing experience using various drop-down menus and/or options menus. These can enable the user to select the same or similar options as those provided in the virtual display options 312, customization options 314, and sharing options 316. Further, the mobile device 318 can include display areas/windows to display the costume window 306 and the virtual environment 308, similar to or the same as for the computing system 300 illustrated in FIG. 3A.

The mobile device 318 can be an e-reader that allows the viewer to scroll through the panels vertically or horizontally. The mobile device 318 can be a user device such as a smartphone, a tablet, or a computer on which an application or software is installed that provides a multi-modal viewing experience by allowing the viewer to view the panels arranged vertically, horizontally, or as a double paged spread. Additionally or alternatively, a viewer can view the digital graphic narrative using web browser displayed on a monitor or display of a computer. The web browser can be used to access a website or content provider that displays the modified graphic narrative within the web browser or an application of the content provider.

FIG. 3C illustrates a VR headset 320. The VR headset 320 can be used to display the virtual environment 308 to a user. The virtual environment 308 can be an augmented reality of three-dimension virtual reality, for example.

FIG. 4 illustrates a system 400 for generating and displaying a digital costume model based on, at least in part, on the digital graphic narrative.

The digital graphic narrative 402 is received by an ingestion processor 404, which ingests a digital version of the digital graphic narrative 402. For example, in the case that the digital graphic narrative is a print version, a digital version of the digital graphic narrative can be generated by scanning physical pages of the digital graphic narrative. The digital version can be a Portable Document Format (PDF) file or another file extension type. The ingestion processor 404 identifies respective areas and boundaries for each of the panels. For example, the ingestion processor 404 can identify the edges of the panels and where the panels flow over or extend beyond nominal boundaries. The ingestion processor 404 determines an order in which the storyline flows from one panel to another, resulting in an ordered set of panels 406, including definitions or boundaries for what constitutes the extent of each of the panels.

The data extraction processor 408 receives the panels 406 and generates therefrom extracted data 412. The data extraction processor 408 can perform an extensive and detailed extraction of stylistic and thematic elements from a corpus of graphic narratives. The data extraction processor 408 can use techniques of image analysis, natural language processing, and pattern recognition to recognize the categories the costumes of characters in one or more graphic narratives. Specific data extraction techniques can include, but are not limited to, edge detection, color analysis, texture analysis, and pattern recognition.

Information can be extracted from panels 406 in various ways, such as by segmenting the images in panels 406 into segmented elements, identifying some of the segmented elements with respective characters and respective costumes worn by the characters, determining how the costumes appear from different angles, and determining candidates for the materials from which the costumes would be made. For example, the candidates for the materials of the costumes can be predicted based on texture and color analyses from the segmented images of panels 406

The panels can be segmented using various methods and techniques, such as semantic segmentation models, which include Fully Convolutional Network (FCN) methods, U-Net methods, SegNet methods, a Pyramid Scene Parsing Network (PSPNet) methods, and DeepLab methods. The data extraction processor 408 can also segment the panels 406 using image segmentation models, such as Mask R-CNN, GrabCut, and OpenCV. The data extraction processor 408 can also segment the panels 406 using Object Detection and Image Segmentation methods, such as fast R-CNN methods, faster R-CNN methods, You Only Look Once (YOLO) methods, PASCAL VOC methods, COCO methods, and ILSVRC methods. The data extraction processor 408 can also segment the panels 406 using Single Shot Detection (SSD) models, such as Single Shot MultiBox Detector methods. The data extraction processor 408 can also segment the panels 406 using detection transformer (DETR) models such as Vision Transformer (ViT) methods.

Many of the above methods identify the objects within the segmented elements, but, for other segmentation methods, a separate step is used to identify the object depicted in the segmented elements. This identification step can be performed using a classifier method or a prediction method. For example, identifying extracted data 412 can be performed using an image classifier, such as K-means methods or Iterative Self-Organizing Data Analysis Technique (ISODATA) methods. The following methods can also be trained to provide object identification capabilities for segmented images: YOLO methods, ResNet methods, VIT methods, a Contrastive Language-Image Pre-Training (CLIP) methods, convolutional neural network (CNN) methods, MobileNet methods, and EfficientNet methods.

The extracted data 412 are received by a costume generation processor 414, which generates a digital costume model 416 based on the extracted data 412 and based on the costume database 410. The costume database 410 can maintain a lookup table of commercially available materials and colors, their costs, their material properties, and the costs and times required for working with the materials. Further, the costume database 410 can maintain a lookup table of commercial fabrication processes, including different types of tailoring (e.g., different types stitching, pleats, cuts, etc.) three-dimensional (3D) printing, machining, coating, and their respective costs and lead times.

The costume generation processor 414 can include AI and/or ML methods that are trained to predict which types of materials and production processes result in a physical costume that most closely matches the images and data captured in the extracted data 412. Further, the costume generation processor 414 can predict the cost of making the costume. According to certain non-limiting examples, the costume generation processor 414 can provide a user with several different options for materials and manufacturing processes that match different price points.

The costume generation processor 414 can search the costume database 410 for materials and production processes that produce costumes similar to those worn by characters in the digital graphic narrative. The costume generation processor 414 can then recommend costumes based on the selected materials and production processes as candidates for costume model 416. The user can receive the automated recommendations and select one or more of the proposed candidates to actualize the costume model 416, and using the virtual experience generator 426 the user can have portions of the digital graphic narrative redrawn to feature an avatar of themselves wearing a virtual rendering of the digital costume model within the context of the digital graphic narrative.

The virtual experience generator 426 includes a virtual experience generator 426 that generates a virtual environment 308, and then the renderer 432 uses the virtual environment model 430 to render a virtual environment 308. For example, the virtual environment model 430 can be based on the extracted data 412 to generate a virtual environment 308 that has a similar style and feel as the digital graphic narrative.

The virtual experience generator 426 can use one or more generative AI methods to create, based on the original image, a proposed image that features of the product. The generative AI methods can use, e.g., generative adversarial network (GAN) methods, variational autoencoders (VAEs) methods, Deep Dream methods, Neural Style Transfer methods, and/or Stable Diffusion Generator methods. These can be trained using the author's/illustrator's work product that is in the same style as the digital graphic narrative to generate images or 3D environments that are consistent with (or seamlessly integrate with) the digital graphic narrative.

The renderer 432 takes the virtual environment model 430 and determines how to render them for a particular device and in a particular user interface (UI) or user experience (UX) that is being used for viewing the virtual environment model 430 of the digital graphic narrative.

The virtual experience generator 426 can use augmented reality (AR) and/or virtual reality (VR) technologies to create an immersive environment. Users can virtually dress up in the generated costumes and engage with the world of the digital graphic narrative. The virtual experience generator 426 may also use motion tracking and facial recognition technology for enhanced user experience.

The sharing processor 418 facilitates sharing of images and information of the costume by itself or in the virtual environment 308 on various platforms such as social media, fan forums, and dedicated community spaces. The sharing processor 418 can incorporate user tagging, location tagging, and the ability to add descriptions and comments.

The customization processor 420 can use AI-assisted design tools (e.g., a chatbot using a transformer neural network and/or an AI recommender system) that provide recommendations and guide a user through a customization process, allowing the users to modify both the virtual and real-life costumes according to their preferences. The customization processor 420 can take into account user inputs such as their measurements, favorite colors, and materials to further personalize the digital costume model 416.

The costume production processor 422 can send a request to a production center that uses manufacturing technologies such as 3D printing, fabric printing, and laser cutting to transform virtual costumes into real-life costumes. The costume production processor 422 can use input values of user measurements and preferences, and material properties to ensure the accuracy, fit, and comfort of the physical costume 424.

According to certain non-limiting examples, the data extraction processor 408 performs an extensive and detailed extraction of stylistic and thematic elements from a comic book data corpus that includes the digital graphic narrative. The data extraction processor 408 can use advanced techniques of image analysis, natural language processing, and pattern recognition. Specific data extraction techniques can include edge detection, color analysis, texture analysis, and pattern recognition.

According to certain non-limiting examples, the costume generation processor 414 can use ML algorithms, including generative adversarial networks (GANs), variational autoencoders (VAEs), or stable diffusion. The costume generation processor 414 uses the extracted data to learn the underlying patterns and relationships of character styles and costumes, generating highly accurate and detailed virtual cosplay costumes. The costume generation processor 414 can use feedback loops for iterative improvements and can take user-specific inputs such as personal photographs for further personalization.

According to certain non-limiting examples, the virtual experience processor 428 can use advanced AR and VR technologies to create an immersive environment. Users can virtually dress up in the generated costumes and engage with the world of the digital graphic narrative. The virtual experience generator 426 can also use motion tracking and facial recognition technology for enhanced user experience.

According to certain non-limiting examples, the costume production processor 422 can use manufacturing technologies such as 3D printing, fabric printing, and laser cutting to transform virtual costumes into real-life costumes. The costume production processor 422 can account for user measurements, user preferences, and material properties to ensure accuracy and comfort.

According to certain non-limiting examples, the customization processor 420 can use AI-assisted design tools to allow users to modify both the virtual and real-life components of the digital costume model according to the user's preferences. The customization processor 420 can account for user inputs such as their measurements, favorite colors, and materials to further personalize the costumes.

According to certain non-limiting examples, the sharing processor 418 can facilitate social sharing of the digital costume model 416 (e.g., information about and images of the virtual and real-life costume) on various platforms such as social media, fan forums, and dedicated community spaces. The sharing processor 418 can incorporate user tagging, location tagging, and the ability to add descriptions and comments.

The system 400 can be distributed across multiple computing platforms and devices. For example, processors 404, 408, 414, 418, 420, 422, and 428 can be located on a computing system 300 of the author/editor or in a cloud computing environment.

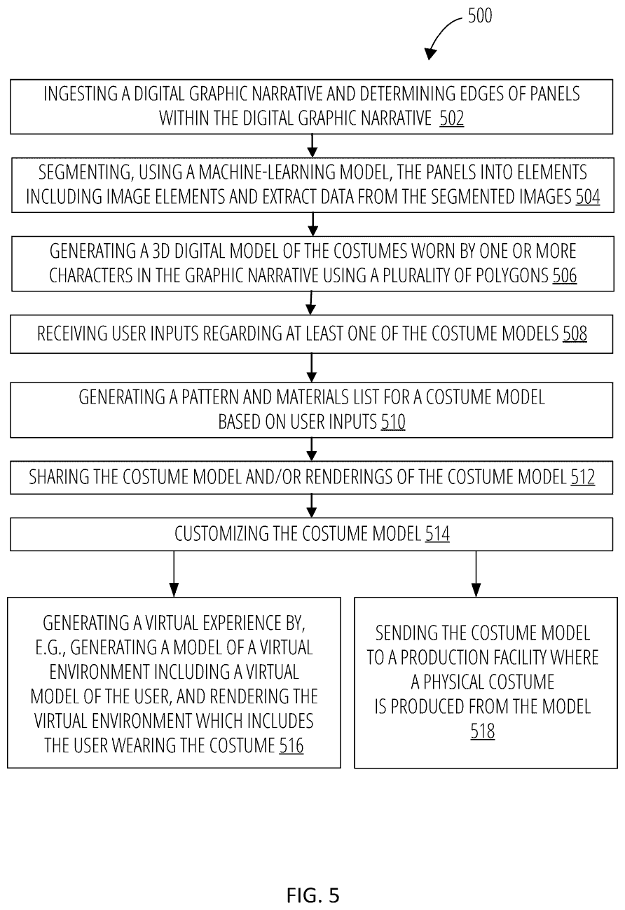

FIG. 5 illustrates an example method 500 for enabling users to generate and interact with a digital costume model based on a digital graphic narrative. Although the example method 500 depicts a particular sequence of operations, the sequence may be altered without departing from the scope of the present disclosure. For example, some of the operations depicted may be performed in parallel or in a different sequence that does not materially affect the function of method 500. In other examples, different components of an example device or system that implements the method 500 may perform functions at substantially the same time or in a specific sequence.

According to certain non-limiting examples, step 502 of the method includes ingesting a digital graphic narrative and determining edges of panels within the digital graphic narrative. Step 502 can be performed by the ingestion processor 404 in FIG. 4, for example.

According to certain non-limiting examples, step 504 of the method includes segmenting, using in a machine-learning model, the panels into elements including image elements and extracting data from the elements. Step 504 can be performed by the data extraction processor 408 in FIG. 4, for example. The segmentation can be performed, e.g., using semantic segmentation models (e.g., FCN, U-Net, SegNet, PSPNet, DeepLab, etc) that perform semantic segmentation using an Encoder-Decoder structure or Multi-Scale representation structure, thereby generating distinct segments that correspond to respective elements within each of the panels and extracting aspects such as color and texture from the image segments.

The segmented elements can include background, foreground, text bubbles, text blocks, and onomatopoeia, and the background and foreground can be further sub-divided into individual characters, objects, and buildings. According to certain non-limiting examples, step 504 can further include identifying objects depicted in the image elements. Step 510 can be performed by the data extraction processor 408 in FIG. 4, for example. Object identification and pattern recognition models, which are discussed with reference to FIG. 4, can be used to perform step 504.

According to some examples, in step 506, a three-dimensional digital model is generated of the costumes worn by one or more characters in the digital graphic narrative using a plurality of polygons. Step 506 can be performed by the costume generation processor 414 in FIG. 4 and using the methods and techniques described with reference thereto, for example.

According to some examples, at step 508, the method includes receiving user inputs regarding the digital costume model. Step 506 can be performed, e.g., using one of the graphical user interfaces illustrated in FIG. 3A and FIG. 3B, and the techniques described with reference to FIG. 4, for example.

According to some examples, the method includes generating a pattern (e.g., a block pattern) and materials list for a costume model based on user inputs at step 510. In some cases, the pattern is one that requires further physical or virtual seamwork or textile work to result in a real-world tangible costume model or a digital costume model, respectively.

According to some examples, in step 512, the costume model and/or renderings of the costume model are shared with others, e.g., on a social media platform. Step 512 can be performed by the sharing processor 418 in FIG. 4 and using the methods and techniques described with reference thereto, for example.

According to some examples, in step 514, the costume model can be modified. Step 514 can be performed by the customization processor 420 in FIG. 4 and using the methods and techniques described with reference thereto, for example. In some cases, the modification includes virtual seamwork or textile work to customize the costume model. In some cases, the modifications include a change in intricacy of the details. For example, a more intricate pattern may include more pieces to be stitched together and/or more types of material or more expensive types of material, which may require a different pattern.

According to some examples, in step 516, a virtual experience is generated by, e.g., generating a model of a virtual environment including a virtual model of the user, and rendering the virtual environment which includes the user wearing the costume. Step 516 can be performed by the customization processor 420 in FIG. 4 and using the methods and techniques described with reference thereto, for example.

Step 516 can be realized using one or more of the generative AI methods disclosed in reference to the costume production virtual experience generator 426. Step 516 can include using a GAN method to generate an image that illustrates a virtual environment 308 that includes a stylized rendering of the costume being worn by one of the characters of the digital graphic narrative or by an avatar of the user. The GAN can learn a style of the digital graphic narrative such that the virtual environment 308 can be created or redrawn in the style of the digital graphic narrative. For example, a panel of the digital graphic narrative can be used for the virtual environment 308 and a segmented portion of the panel can be redrawn to illustrate the costume and the user in the digital graphic narrative in accordance with the artistic style of the digital graphic narrative.

According to some examples, the method includes sending the digital costume model to a production facility where a physical costume is produced from the model at step 518. In some cases, the digital costume model, as well as the pattern and materials list, may be rendered into a format that can be used to produce the physical costume.

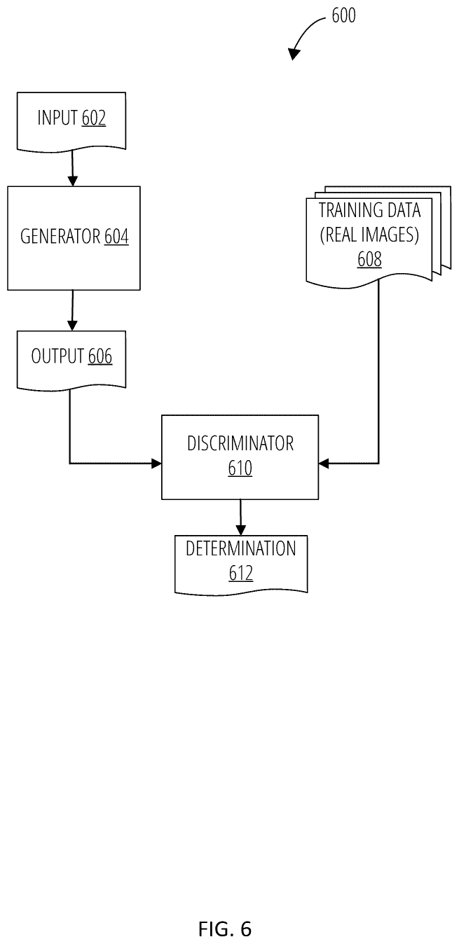

FIG. 6 illustrates a GAN architecture 600. The GAN architecture 600 has two parts: the generator 604 and the discriminator 610. The generator 604 learns to generate plausible images. The discriminator 610 learns to distinguish the plausible images of the generator 604 from real images. The discriminator 610 receives two images (i.e., the output 606 from the generator 604 and a real image from the training data 608), and analyzes the two received images to make a determination 612 which is the real image. The generator 604 fools the discriminator 610 when the determination 612 is incorrect regarding which of the images received by the discriminator 610 was real.

Both the generator and the discriminator are neural networks with weights between nodes in respective layers, and these weights are optimized by training against the training data 608, e.g., using backpropagation. The instances when the generator 604 successfully fools the discriminator 610 become negative training examples for the discriminator 610, and the weights of the discriminator 610 are updated using backpropagation. Similarly, the instances when the generator 604 is unsuccessfully in fooling the discriminator 610 become negative training examples for the generator 604, and the weights of the generator 604 are updated using backpropagation.

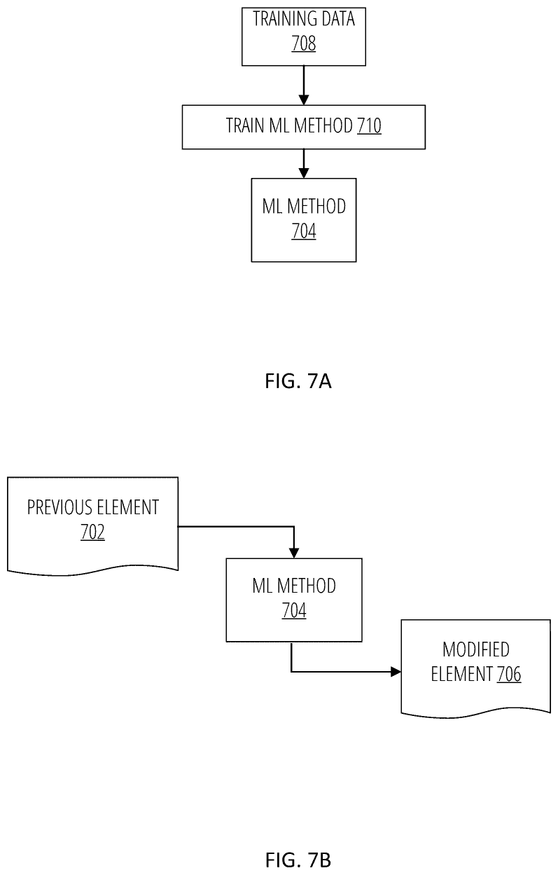

FIG. 7A illustrates an example of training an ML method 704. In step 710, training data previous element 702 is applied to train the ML method 704. For example, the ML method 704 can be an artificial neural network (ANN) that is trained via unsupervised or self-supervised learning using a backpropagation technique to train the weighting parameters between nodes within respective layers of the ANN.

An advantage of the GAN architecture 600 and the transformer neural network architecture is that they can be trained through self-supervised learning or unsupervised methods. The Bidirectional Encoder Representations from Transformer (BERT), for example, does much of its training by taking large corpora of unlabeled text, masking parts of it, and trying to predict the missing parts. It then tunes its parameters based on how much its predictions were close to or far from the actual data. By continuously going through this process, the transformer neural network architecture captures the statistical relations between different words in different contexts. After this pretraining phase, the transformer neural network architecture can be finetuned for a downstream task such as question answering, text summarization, or sentiment analysis by training it on a small number of labeled examples.

In unsupervised learning, the training data 708 is applied as an input to the ML method 704, and an error/loss function is generated by comparing the predictions of the next word in a text from the ML method 704 with the actual word in the text. The coefficients of the ML method 704 can be iteratively updated to reduce an error/loss function. The value of the error/loss function decreases as outputs from the ML method 704 increasingly approximate the training data 708.

For example, in certain implementations, the cost function can use the mean-squared error to minimize the average squared error. In the case of a multilayer perceptrons (MLP) neural network, the backpropagation algorithm can be used for training the network by minimizing the mean-squared-error-based cost function using a gradient descent method.

Training a neural network model essentially means selecting one model from the set of allowed models (or, in a Bayesian framework, determining a distribution over the set of allowed models) that minimizes the cost criterion (i.e., the error value calculated using the error/loss function). Generally, the ANN can be trained using any of numerous algorithms for training neural network models (e.g., by applying optimization theory and statistical estimation).

For example, the optimization method used in training artificial neural networks can use some form of gradient descent, using backpropagation to compute the actual gradients. This is done by taking the derivative of the cost function with respect to the network parameters and then changing those parameters in a gradient-related direction. The backpropagation training algorithm can be: a steepest descent method (e.g., with variable learning rate, with variable learning rate and momentum, and resilient backpropagation), a quasi-Newton method (e.g., Broyden-Fletcher-Goldfarb-Shannon, one step secant, and Levenberg-Marquardt), or a conjugate gradient method (e.g., Fletcher-Reeves update, Polak-Ribiére update, Powell-Beale restart, and scaled conjugate gradient). Additionally, evolutionary methods, such as gene expression programming, simulated annealing, expectation-maximization, non-parametric methods and particle swarm optimization, can also be used for training the ML method 704.

The training of the ML method 704 can also include various techniques to prevent overfitting to the training data 708 and for validating the trained ML method 704. For example, bootstrapping and random sampling of the training data 708 can be used during training.

In addition to supervised learning used to initially train the ML method 704, the ML method 704 can be continuously trained while being used by using reinforcement learning.

Further, other machine learning (ML) algorithms can be used for the ML method 704, and the ML method 704 is not limited to being an ANN. For example, there are many machine-learning models, and the ML method 704 can be based on machine-learning systems that include generative adversarial networks (GANs) that are trained, For example, using pairs of network measurements and their corresponding optimized configurations.

As understood by those of skill in the art, machine-learning based classification techniques can vary depending on the desired implementation. For example, machine-learning classification schemes can utilize one or more of the following, alone or in combination: hidden Markov models, recurrent neural networks (RNNs), convolutional neural networks (CNNs); Deep Learning networks, Bayesian symbolic methods, general adversarial networks (GANs), support vector machines, image registration methods, and/or applicable rule-based systems. Where regression algorithms are used, they can include but are not limited to: a Stochastic Gradient Descent Regressors, and/or Passive Aggressive Regressors, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

FIG. 7B illustrates an example of using the trained ML method 704. The previous element 702 and/or instructions for modifying the previous element 702 are applied as inputs to the trained ML method 704 to generate the outputs, which can include the modified element 706.

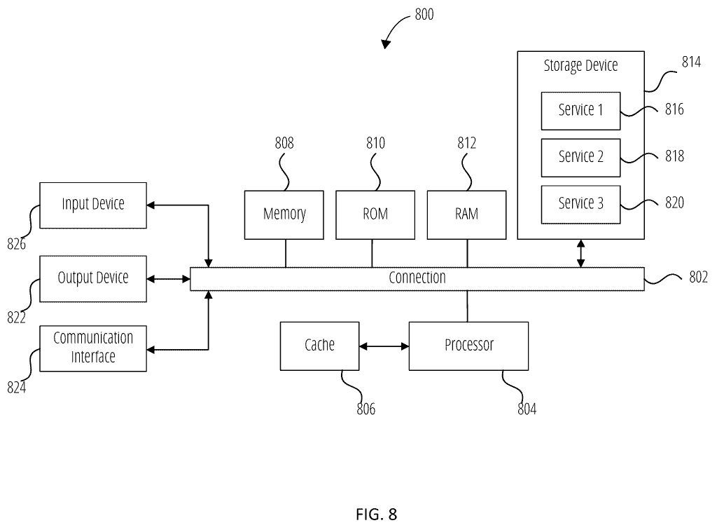

FIG. 8 shows an example of computing system 800. The computing system 800 can be the computing system 300, the mobile device 318, or the VR headset 320. The computing system 800 can perform the functions of one or more of the units in the system 400 and can be used to perform one or more of the steps of method 500. The computing system 800 can be part of a distributed computing network in which several computers perform respective steps in method 500 and/or the functions of units in system 400. The computing system 800 can be connected to the other parts of the distributed computing network via the connection 802 or the communication interface 824. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 804 and connection 802 that couples various system components including system memory 808, such as read-only memory (ROM) 808 and random access memory (RAM) 810 to processor 804. Computing system 800 can include a cache of high-speed memory connected directly with, in close proximity to, or integrated as part of processor 804. Processor 804 may essentially be a completely self-contained computing system, containing multiple cores or processors, a bus, memory controller, cache, etc. A multi-core processor may be symmetric or asymmetric.

Processor 804 can include any general purpose processor and a hardware service or software service, such as services 816, 818, and 820 stored in storage device 814, configured to control processor 804 as well as a special-purpose processor where software instructions are incorporated into the actual processor design. Service 1 816 can be identifying the extent of a flow between the respective panels, for example. Service 2 818 can include segmenting the each of the panels into segmented elements (e.g., background, foreground, characters, objects, text bubbles, text blocks, etc.) and identifying the content of the each of the segmented elements. Service 3 820 can be identifying candidate products to be promoted in the segmented elements, and then selecting from among the candidate products and segmented elements which elements are to be modified to promote which selected products. Additional services that are not shown can include modifying the selected elements to promote the selected products, and integrating the modified elements into the digital graphic narrative.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include a communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that when the code that defines such software is executed by the processor 804, it causes the system to perform a function. In some embodiments, a hardware service that performs a particular function can include the software component stored in a computer-readable medium in connection with the necessary hardware components, such as processor 804, connection 802, output device 822, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a system 400 and perform one or more functions of the method 500 when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer readable media. Such instructions can comprise, For example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of generating a digital costume model based, in part, on images from a digital graphic narrative, comprising:
segmenting, using at least one machine-learning model, elements within images of a two-dimensional digital graphic narrative;
identifying, using the at least one machine-learning model, segmented elements, wherein the identified segmented elements include clothing elements worn by characters in the two-dimensional digital graphic narrative;
analyzing, using the at least one machine-learning model, the identified clothing elements to extract and predict a plurality of polygons that represent the identified clothing elements in a digital three-dimensional shape; and
generating a three-dimensional digital costume model based, in part, on the plurality of polygons.

2. The method of claim 1, further comprising:
ingesting pages of the digital graphic narrative, wherein the digital graphic narrative comprises at least one of a digital version or a print version selected from the group consisting of comic books, manga, manhwa, and manhua, cartoons, and anime; and
identifying panels within the pages of the digital graphic narrative, and then segmenting the elements within images of the panels of the digital graphic narrative.

3. The method of claim 2, wherein segmenting the elements within the panels further comprises:
applying a first machine learning (ML) method to a panel of the panels, the first ML method determining, within the panel, bounded regions corresponding background, foreground, text bubbles, objects, and/or characters, and identifying the bounded regions as the segmented elements.

4. The method of claim 1, further comprising:
generating a model for a three-dimensional virtual environment including a virtual costume based on the three-dimensional digital costume model that fits on a wireframe associated with a character; and
rendering the three-dimensional virtual environment.

5. The method of claim 4, wherein rendering the three-dimensional virtual environment further comprises:
showing an avatar of a user wearing a three-dimensional virtual costume based on the digital costume model, and the three-dimensional virtual environment is rendered in a style of the digital graphic narrative.

6. The method of claim 4, wherein the three-dimensional virtual environment is an immersive environment rendered using a virtual reality (VR) technology or an augmented reality (VR) technology.

7. The method of claim 4, wherein the three-dimensional virtual environment is generated using a generative adversarial network (GAN), a variational autoencoder (VAE), or stable diffusion.

8. The method of claim 1, wherein analyzing, using the at least one machine-learning model, the clothing elements to extract and predict the plurality of polygons further comprises:
identifying a plurality of clothing elements from different images of the digital graphic narrative that correspond to a same costume of a same character of the digital graphic narrative;
identifying respective orientations of the plurality of clothing elements from the different images of the digital graphic narrative;
identifying one or more colors of the plurality of clothing elements; and
identifying one or more textures of the plurality of clothing elements.

9. The method of claim 8, wherein generating the digital costume model further comprises:
determining matches between costume materials and the identified one or more colors and between the costume materials and the identified one or more textures;
determining the digital costume model based on the matches; and
generating a list of materials, quantities of the materials, and instructions for fabricating a physical costume based on the digital costume model.

10. The method of claim 9, further comprising:
sending a request to fabricate the physical costume based on the list of materials, the quantities of the materials, and the instructions.

11. The method of claim 9, wherein the instructions for fabricating the physical costume include: a tailoring pattern for cutting and sewing respective pieces of cloth, three-dimensional printing instructions, fabric printing instructions, and/or laser cutting instructions.

12. The method of claim 1, further comprising:
receiving user inputs indicating changes to the digital costume model; and
customizing the digital costume model based on the user inputs.

13. The method of claim 12, wherein receiving the user inputs further comprises using an artificial intelligence method to guide a user through setting customization parameters as the user inputs.

14. The method of claim 12, wherein the digital costume model includes an animated component and a real-life component, the animated component representing an appearance of the digital costume model when rendered for an animated virtual environment, and the real-life component representing an appearance of the digital costume model when rendered to show how a physical costume is predicted to appear; and
the method further comprises customizing the animated component of the digital costume model independently of the real-life component of the digital costume model.

15. The method of claim 1, further comprising:
sharing, on one or more social sharing platforms, information about the digital costume model and/or images based on the digital costume model.

16. The method of claim 15, wherein the one or more social sharing platforms comprises social media, a fan forum, a virtual forum, and online community, a chart room, a public forum, or a virtual community space.

17. The method of claim 1, wherein identifying segmented elements is performed, at least in part, using a machine learning (ML) method.

18. The method of claim 17, wherein the ML method is selected from the group consisting of a Fully Convolutional Network (FCN) method, a U-Net method, a SegNet method, a Pyramid Scene Parsing Network (PSPNet) method, a DeepLab method, a Mask R-CNN, an Object Detection and Segmentation method, a fast R-CNN method, a faster R-CNN method, a You Only Look Once (YOLO) method, a fast R-CNN method, a PASCAL VOC method, a COCO method, a ILSVRC method, a Single Shot Detection (SSD) method, a Single Shot MultiBox Detector method, a Vision Transformer, ViT) method, a K-means method, an Iterative Self-Organizing Data Analysis Technique (ISODATA) method, a YOLO method. A ResNet method, a ViT method, a Contrastive Language-Image Pre-Training (CLIP) method, a convolutional neural network (CNN) method, a MobileNet method, and an EfficientNet method.

19. A computing apparatus comprising:
a processor; and
a memory storing instructions that, when executed by the processor, configure the apparatus to:
segment, using at least one machine-learning model, elements within images of a two-dimensional digital graphic narrative;
identify, using the at least one machine-learning model, segmented elements, wherein the identified segmented elements include identified clothing elements worn by characters in the two-dimensional digital graphic narrative;
analyze, using the at least one machine-learning model, the clothing elements to extract and predict a plurality of polygons that represent the clothing elements in a digital three-dimensional shape; and
generate a three-dimensional digital costume model based, in part, on the plurality of polygons.

20. The computing apparatus of claim 19, wherein, when executed by the processor, the stored instructions further configure the apparatus to:
receive user inputs indicating changes to the digital costume model, and customize the digital costume model based on the user inputs;
share, on one or more social sharing platforms, information about the digital costume model or images based on the digital costume model; and
generate a model of a virtual environment comprising a virtual costume based on the digital costume model, render the virtual environment.
